(19) United States
(12) Patent Application Publication
(10) Pub. No.: US 2021/0263484 A1
(43) Pub. Date: Aug. 26, 2021

(54) SYSTEMS AND METHODS FOR MANIPULATING THE SHAPE AND BEHAVIOR OF A PHYSICAL SPACE

(71) Applicant: TheMissionZone, Inc., Derry, NH (US)

(72) Inventor: Joshua Rutstein, Derry, NH (US)

(21) Appl. No.: 17/256,312

(22) PCT Filed: Jun. 28, 2019
(86) PCT No.: PCT/US2019/039841

§ 371 Date: Dec. 28, 2020

Related U.S. Application Data
(60) Provisional application No. 62/694,227, filed on Jul. 5, 2018.

(51) Int. Cl. G05B 13/02; G06Q 10/10; G06Q 10/06; G09B 5/12

(52) U.S. Cl. CPC G05B 13/0265; G06Q 10/109; G09B 7/00; G06Q 10/06315; G09B 5/125; G06Q 10/101

(57) ABSTRACT

A method includes receiving content that describes a mission for participants where the participants attempt to complete tasks in a physical zone. Completing the tasks may require an understanding of training materials. The method includes providing or constructing the physical zone (with physical components therein) where a mission can take place. The method includes receiving parameters about the physical zone. The parameters may describe the physical zone itself and/or one or more physical components in the physical zone. The method includes comparing the content of the mission to the parameters that describe the physical zone to determine whether the mission can be undertaken in the physical zone. If so, then the method includes presenting the mission and the physical zone as an option for the participants. The method includes controlling the physical components while the participants are undertaking the mission.

### CROSS-REFERENCE TO RELATED APPLICATIONS

This application claims the benefit of U.S. Provisional Patent Application Ser. No. 62/694,227, filed Jul. 5, 2018, entitled “SYSTEMS AND METHODS FOR MANIPULATING THE SHAPE AND BEHAVIOR OF A PHYSICAL SPACE,” which is incorporated by reference herein in its entirety.

### FIELD OF THE INVENTION

This disclosure relates to systems and methods for manipulating the shape and behavior of a physical space.

### BACKGROUND

Real world adventure games, such escape rooms or the like, have become popular in many parts of the world. A typical escape room has both physical and mental aspects that require players, or participants, to solve a series of puzzles or riddles using clues, hints, and strategies in a physical space to complete the objectives at hand. Usually, players are given a set time limit to complete the challenges required to “escape.” Escape rooms can be great fun for its participants. Once established, a typical escape room can accommodate one type of adventure game. If other adventure games are desired, a new escape room, and scenario, are devised.

### SUMMARY OF THE INVENTION

In one aspect, a method includes receiving content at a computer system. The content describes a mission for participants that involves the participants attempting to complete one or more tasks in a physical zone. Completing at least some of the tasks may require an understanding by the participants of training materials. However, in some implementations, there may be no training materials and the mission may be for entertainment purposes only, or primarily. The method also includes providing or constructing the physical zone where one or more missions can take place, and providing one or more physical components that the participants can interact with when undertaking the mission in the physical zone. The method includes receiving parameters about the physical zone at the computer system. The parameters may describe the physical zone itself and/or one or more physical components in the physical zone. The method includes comparing the content of the mission to the parameters that describe the physical zone to determine, with the computer system, whether the mission can be undertaken in the physical zone. If the computer system determines that the mission can be undertaken in the physical zone, then the method includes presenting the mission and the physical zone as an option for the participants. Additionally, the method includes controlling the one or more physical components in the physical zone with the computer while the participants are undertaking the mission in the physical zone.

In some implementations, the method includes providing training materials to the participants to review before and/or during the mission.

In certain implementations, the method includes receiving signals at the computer system from one or more of the physical components in the physical zone as the participants interact with the one or more physical components while undertaking the mission.

Some implementations include causing, with the computer system, one or more of the physical components (e.g., locks) in the physical space to change state (e.g., to open or close) in response to one or more of the received signal (e.g., a signal indicating that a participant has solved a puzzle related to the training materials).

According to certain implementations, the method includes enabling users (e.g., human content creators) to enter content about different missions into the computer system. The content entered by each respective user can describe and be associated with different missions. Each different mission may involve the participants attempting to complete one or more mission-specific tasks in a mission-specific physical zone. For each different mission, completing at least some of the mission-specific tasks may require an understanding by the participants of mission-specific or generic training materials.

In some implementations, the method includes enabling users to enter parameters at the computer system that describe different physical zones and one or more physical components in each respective one of the different physical zones. In this regard, the computer system, in some implementations, is configured to determine which of the different missions can be undertaken in which of the different physical zones by comparing the content about the different missions with the parameters that describe the different physical zones and the physical components in the different physical zones. The computer system also may be configured to identify to mission participants, at a computer-based user access terminal: one or more of the different missions that can be undertaken at a selected one of the different physical zones, and/or one or more of the different physical zones where a selected one of the different missions can be undertaken. Depending on the specific circumstances, of course, any particular one of the different missions may be able to be undertaken at a particular one of the different physical zones, if requirements of that particular mission set by the content entered for that particular mission, can be satisfied by characteristics of that particular physical zone based on the entered parameters for that particular physical zone.

In some instances, multiple groups of participants can undertake different missions at the same time in one single physical zone—more specifically, in different areas or rooms of one single physical zone. In those instances, the computer system may be configured to control the different areas or rooms of the one single physical zone according to the progress of each respective group of participants.

According to certain implementations, the method includes enabling content creators to leverage content created by others or by themselves for other missions.

The training materials can relate to a wide range of topics including, for example, some real-world training goal that is not related to the mission.

In some implementations, the computer system is configured to set up the one or more physical components in the physical zone prior to the mission taking place in accordance with the content received at the computer system that describes the mission.

The content that describes the mission may be organized (hierarchically) and saved into computer-based memory as mission information, objective information, and task information. Each mission may include (and be built upon) one or more objectives, and each objective may include (and be built upon) one or more tasks. In some implementations, the tasks are logically associated in the computer-based memory with one or more physical devices that must be present as a component in a room of the physical zone in order for the physical zone to be able to support a corresponding mission (that includes those tasks). In some implementations, each objective may be logically associated in the computer-based memory with a corresponding room in the physical zone that has every device that is required to support any tasks associated with that objective. The objective information and the task information may be stored such that each objective can be readily associated with a corresponding new mission, and such that each task can be readily associated with a corresponding new objective or mission.

In certain implementations, comparing the content of the mission to the physical zone parameters (for suitability purposes) includes: determining whether a room type associated with the mission content is represented in the physical zone parameters; and, if so, determining if a device associated with a task to be performed in the room type as represented in the mission content is represented in the physical zone parameters.

The system, in some implementations, is configured to coordinate two or more missions being undertaken utilizing different rooms (at the same time) in the same physical zone to accommodate different objectives in the different rooms for the different missions.

In another aspect, a system includes: a physical zone where one or more missions can be undertaken. Each physical zone is defined at least in part, by walls that define rooms or spaces within which participant action can occur. There are one or more physical components in the physical zone that the participants can interact with when undertaking one of the missions in the physical zone. A computer system is configured to receive signals from the one or more physical components as the participants interact with the one or more physical components during the mission being undertaken, and to control the one or more physical components in response to the signals received. The computer system may be further configured to: receive content that describes a mission for participants that involves the participants attempting to complete one or more tasks in the physical zone. Completing at least some of the tasks may require an understanding by the participants of training materials. The computer system also may be configured to receive parameters that describe the physical zone and the one or more physical components in the physical zone. The computer zone also may be configured to compare the content of the mission to the parameters that describe the physical zone to determine whether the mission can be undertaken in the physical zone, and, if the computer system determines that the mission can be undertaken in the physical zone, present the mission and physical zone as an option for the participants at a user access terminal.

In some implementations, one or more of the following advantages are present.

For example, in some implementations, it is possible for a space to change its shape, the way it behaves and the parameters of that space, based on a pre-programmed script and the actions of a person or people in that space. A person or a group of people can elect to enter a space that is governed by a selected program and depending on how they interact with the space and the program. A System reacts to those inputs. That System can unlock doors/portals/passages, change images on a screen, manipulate lights and sounds, move objects, reposition walls, and reshape objects as that person or people move around and interact with data inputs to the program. Manipulating the space, allows a person or people to interact with a computer System for entertainment purposes or to facilitate education through experiential learning concepts. In essence, an adventure is created in theory and then a person or people act it out in the real world space. Further, a single space can be programmed to enable an infinite number of adventures by the way the plot line and space design, are affected on the actual playing space.

Also, immersive experiences are more engaging for people to enjoy the world around them. These have taken many forms. Each experience requires infrastructure and thematic programming. Up until this point most Content and physical environment solutions are not scalable. To enable this kind of bespoke capability to the masses at a cost-affordable price, there needs to be a way to create scalability. The Systems and techniques described herein enable several forms of scalability.
1. Because the Rooms are controlled by the System, the System has the ability to run multiple Missions in a single Room at different times.
2. Because the Zone is controlled by the System, multiple Missions can be running simultaneously in either separate Rooms, or even sharing the same Room, allowing Players to interact with each other.
3. Because the System controls the Zone based on rules and configurations, any person can create Content for the platform.
4. Because Content is created by anyone, the number of Missions on the platform is limitless.
5. Because Content is based on space configurations and rules, any space (Zone) can be configured through the use of standard Devices to execute a Mission.
6. Because the System controls the operations of a Zone, the administrative burden is limited and does not increase proportionately with either more Content or more Players.
7. Because a System controls the physical behavior and actions of any space, the space size is not limited. A space need only be logged with its Rooms, characteristics and Devices to be categorized as a Zone and managed by the System.

Other features and advantages will be apparent from the description and drawings, and from the claims.

### BRIEF DESCRIPTION OF THE DRAWINGS

FIG. 1 is a schematic representation of a system that includes a physical zone where one or more missions can be undertaken.

FIG. 2 is an exemplary schematic representation of the system in FIG. 1 showing, schematically, the role of each particular type of person (content creators, zone managers, and players) that might interact with the system.

FIG. 3 shows information from an exemplary mission header record used by the system.

FIG. 4 and FIG. 5 show sample data items.

FIG. 6 shows a sample floorplan of a zone with rooms and components (devices).

FIG. 7 is a graphical depiction of an exemplary system's algorithm for assessing room type/device to zone feasibility.

FIG. 8 represents how an exemplary system associates objectives, rooms, tasks, devices, and preparations for a particular mission.

FIG. 9 represents how an exemplary system associates devices within a room for an objective in a mission.

FIG. 10 represents how an exemplary system associates device interactions for an objective in a mission.

FIG. 11 represents how an exemplary system manages multiple missions for different players (or groups of players) in different parts of the same physical zone.

FIG. 12 is an exemplary computer-based memory and processing system.

### DETAILED DESCRIPTION

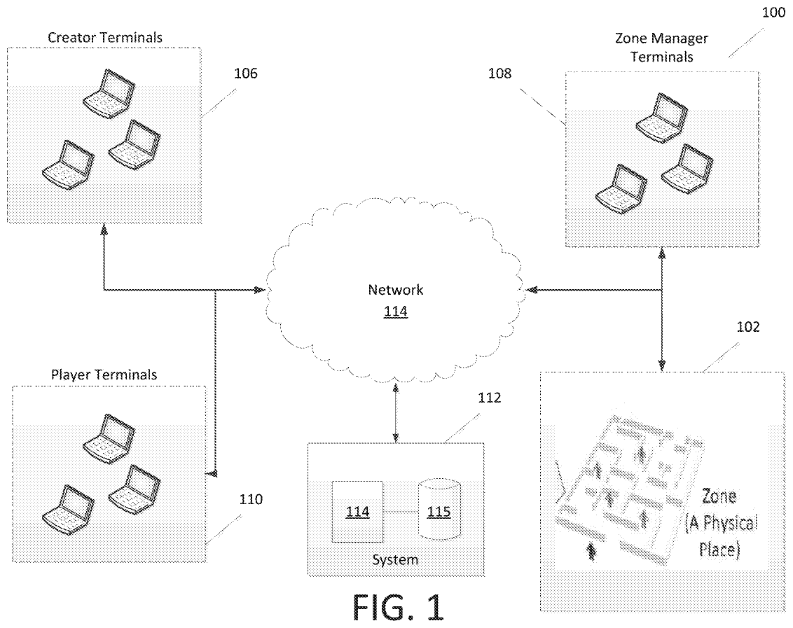

FIG. 1 is a schematic representation of a system 100 that includes a physical zone 102 where one or more missions can be undertaken. In a typical implementation, a mission is a set of physical and mental activities for participants to perform in the physical zone 102, the successful completion of which will require the participants to illustrate an understanding of certain training materials. Each mission may include, or be associated with, an optional, fictional story line that goes along with the physical and mental activities.

According to one example, a mission may include a fictional story whereby the participants are supposed to try escape from an evil-doer's lair. In this example, the physical zone 102 may be a life-size mock-up of the lair and may include a series of physical obstacles (e.g., components or objects such as locked doors, locked windows, locked containers, or computer terminals that require passwords or codes to open or access, etc.) and information, either hidden, coded, or out in the open in the physical zone 102. Advancing through, or completing, the mission (e.g., escaping from the lair) may require the participants to complete a series of physical and/or mental activities, some of which may involve one or more of the physical obstacles, one or more of the pieces of information, and/or one or more pieces of information from the training materials.

Typically, the training materials will have been given to the participants in advance of the mission to study and learn. The training materials can relate to just about anything. Some examples may include new company policies, materials from high school or college classes, technical training materials, etc. In general, if a particular mission has associated training materials, then the training materials will relate to some real-world training goal that is not necessarily related to the mission.

The physical and mental activities can include virtually any kind of physical and mental activities, such as, solving problems, answering questions, entering codes into electronic or mechanical devices, unlocking locks, and opening doors, climbing in, on, or over objects, crawling under objects, or otherwise interacting with physical and/or electronic/computer-based objects or components at the physical zone 102. The participants in this example can complete a particular mission by completing whatever prescribed set of physical and mental activities in the physical zone 102 may have been associated with the mission.

In various implementations, the participants may voluntarily undertake a mission for fun, learning, team building, or some combination of these reasons.

FIG. 1 is an example of a system 100 for providing this kind of mission experience (with potentially multiple different missions being available) in a manner that is easy to customize for different groups of participants and that is highly scalable.

The physical zone 102 in the illustrated implementation includes a plurality of walls that define a maze, through which the participants can move.

In a typical implementation, there are physical components (e.g., locked doors or other obstacles) in the physical zone 102 that the participants can interact with, mentally or physically, when undertaking a mission in the physical zone 102. At least some of the locked doors or other obstacles may require problem solving (based, in part, on the training materials) or the like to open or traverse.

The system 100 also has a computer system 104 associated with the physical zone 102 and configured to interact with components in the physical zone 102 while a mission is being undertaken. These interactions may include, for example, sending and/or receiving electronic signals to and/or from the components while the mission is being undertaken in the physical zone 102.

The illustrated computer system 104 has creator terminals 106, zone manager terminals 108, player terminals 110, and a computer-based memory and processing system 112, all connected together over a network 114 (e.g., the Internet or any other communications network). The computer-based memory and processing system 112 has a computer-based memory device 115 and a computer-based processor 116.

The creator terminals 106 provide a computer-based interface to the system 100 for content creators (i.e., people who create content—missions—or enter information about the missions into the system 100). In some implementations, the creator terminals 106 enable content creators (e.g., humans) to enter into the system 104 information that specifies and characterizes new missions, physical zone 102 requirements to support or accommodate the new missions, and/or training materials (if any) associated with the new missions. In a typical implementation, the creator terminals 106 may be configured to prompt the content creators to enter specific types of information that is relevant to a created mission, its physical zone requirements and/or the associated training materials.

In some implementations, different content creators may enter different content about different missions, for different physical zones, with different training materials, at different creator terminals. The content may be entered in the computer system 104 by different types of people. In some instances, content may be entered by people who work for the company that operates the system 100. In some implementations, content may entered in the computer system 104 by people that do not work for the company that operates the system 100, but instead, by potential participants of the system. For example, an organization's human resources group may enter content for a mission that the organization's employees will undertake to learn training materials relating to a new human resources policy. In some implementations, the system is configured so as to enable content creators to leverage content created by others or to leverage content created previously by themselves for other missions.

In some implementations, the content entered at the creator terminals 106 is saved in the computer-based memory device 114 of the computer-based memory and processing system 112. However, in some implementations, the content may be saved at one or more other convenient memory storage locations throughout the system 100.

The zone manager terminals 108 provide a computer-based interface for zone managers (i.e., anyone tasked with managing a particular physical zone 102 and the missions associated therewith). In a typical implementation, a zone manager terminal 108 enables a zone manager to initiate a mission for a group of participants at the physical zone 102, monitor the group's progress through the mission, and/or interact with one or more components (e.g., audio speakers or the like) in the physical zone to interact with the participants during a mission and/or otherwise adapt the mission in real time. In some implementations, the zone manager terminals 108 provide other functionalities that might be convenient or helpful to a party whose job it is to manage a particular physical zone 102 and the missions that are undertaken at the zone 102. These functionalities can include, for example, monitoring and storing performance metrics, handling and tracking financial information (e.g., information about costs and payments, etc.), etc.

The player terminals 110 provide a computer-based interface to the system 100 for players (e.g., mission participants, prospective or otherwise). In a typical implementation, the player terminals allow the participants to access information about available missions at one or more physical zones. In some implementations, the player terminals 110 are configured to prompt the players to select missions from a plurality of available missions based on the physical zones that are available where the selected mission will be undertaken. Also, in some implementations, the player terminals 110 enable the players to access performance metrics, photographs, and/or training materials associated with particular missions.

In some implementations, the computer system 104 (e.g., the computer-based memory and processing system 112) is configured to compare the content of each mission to the parameters that describe each available physical zone to determine whether the mission can be undertaken in the physical zone, and, if the computer system 104 determines that the mission can be undertaken in the physical zone, it presents the mission and physical zone as one, of perhaps several, options for a participant at one of the player terminals 110 to consider for selection.

In some implementations, some terminals in a particular system 100 may perform multiple roles. For example, if a prospective player might utilize his or her terminal to create content for the system 100, then that person's terminal might be a creator terminal and a player terminal.

The computer-based memory and processing system 112 in the illustrated system 100 provides at least some of the processing and memory storage required to facilitate and support system performance according to the current disclosure. In this regard, in some implementations, the computer system 104 (e.g., the computer-based memory and processing system 112) is configured to monitor and/or control various components in the physical zone 102 in accordance with electronically stored information about the mission being undertaken and/or in response to actions that the participants take in the physical zone where the mission is being undertaken. In a typical implementation, this monitoring and/or controlling is implemented automatically (i.e., without requiring input from a human outside of the physical zone 102 after the mission is initiated and while the mission is being undertaken).

During a mission, in a typical implementation, the computer system 104 receives signals from the one or more physical components in the physical zone as the participants interact with the one or more physical components during the mission being undertaken. In a typical implementation, the computer system 104 is able to cause one or more of the physical components in the physical zone or space 102 to change state in response to one or more of the received signal. For example, in response to a signal from a computer terminal in the physical zone indicating that a participant has solved a riddle (related to associated training materials), the computer system 104 may cause a lock on a door in the physical zone 102 to unlock.

In a typical implementation, for each physical zone, multiple groups of participants can undertake different missions (or different instances or versions of the same mission) at the same time in different parts of the physical zone.

What follows is a description of certain exemplary implementations. As used herein, terminology should generally be interpreted in accordance with its ordinary meaning. In addition, in some instances, some of the following commentary may be applicable as well.
System or computer system—This may refer to a technology component that lays over the concepts disclosed herein. In some implementations, the system or computer system receives inputs, evaluates a program, and then affects the appropriate changes in the physical space to create an experience for a player or participant.
Zone—In some implementations, a zone maybe considered a physical location for a facility that enables a mission to be navigated by players or participants subscribing to, or signed up for a mission.
Mission information—Mission information may refer to the structured logic and/or information needed for a system to control the rooms and/or components within a zone and enable players or participants to solve multi-step thematic challenges, for example. Mission information may include, for example, a plot, materials, challenges, questions, formulas, data inputs, correct answers, room designations and/or sequences that are necessary to support system operations.
Quest—In some implementations, a quest may refer to multiple missions linked together to create a longer narrative.
Plot—A plot may be considered a story line that accompanies a mission or quest. A plot typically helps make the mission or quest more interesting and engaging.
Player (or participant)—The person or people that engage with a zone to undertake a Mission. In a typical implementation, this person or people may prepare for the mission, conduct research, study training materials, and/or gather equipment and tools, and then physically embark on solving the mission's challenges by moving around the zone and interacting with it and the components within the zone.
Administrator—In a typical implementation, an administrator is a person who maintains the computer system that controls aspects of the mission and that affects changes in the zone. Administrators may be tasked with making sure that the computer system is executing correctly and also with deploying new technical capabilities to the platform that governs the zone and mission.
Creator—In a typical implementation, a creator is a person or people who conceive of, and enter into the system, the structure of a mission including, for example, the plot, objective(s), task(s), and/or materials needed and correct responses to challenges or questions posed during the mission. The creator may key this information into the controlling system through an interface that allows configuration of the program's logic structures. A creator may leverage existing technical capabilities to create the mission; they generally are not creating new capabilities (like the administrator who creates new technical capabilities).
Training Materials—Technical materials may include, for example, materials in the form of documentation, videos, apps, websites or anything that can teach a person some piece of information. These enable players (or participants) to prepare for the mission or conduct the mission. Training materials may be provided to the players (or participants) before or while the players (or participants) are undertaking a mission.
Content—Content is a general term used to describe a collection of information (e.g., plot, theme, mission configuration and experiences on a platform), combined with training materials used to educate players (or participants).
Room—In general, a room may be considered one physically defined space within a zone. A whole series of attributes may be connected to a room and allow the system to interpret how best to control that room as part of the functionality of the overall zone as it relates to the mission's plot line.
Device—In some implementations, a device is a technical piece of equipment that affects actions either from or to the system. Some devices may receive instructions from the system (e.g., door locks, display screens, lights, speakers playing sounds, motors that move objects). Other devices may send information to the system (e.g., keypads, motion sensors, tablets, cell phone interfaces). Some devices, like computer tablets, may or can do both.
Objective—An objective may be considered a purpose for a particular room. This may be thematic and related to the overall plot line.
Task—A task may be considered an act or thing that needs to be done within a room to complete an objective. A task can be physical, mental, academic, systemic, or a combination thereof.
Challenge response—For each task (or challenge), a player may need to provide a correct input or answer, or perform some action. A player may do this as a challenge response to the system for evaluation. These can be either correct or incorrect for that task. Not all tasks have challenge responses that need to be submitted to the system.

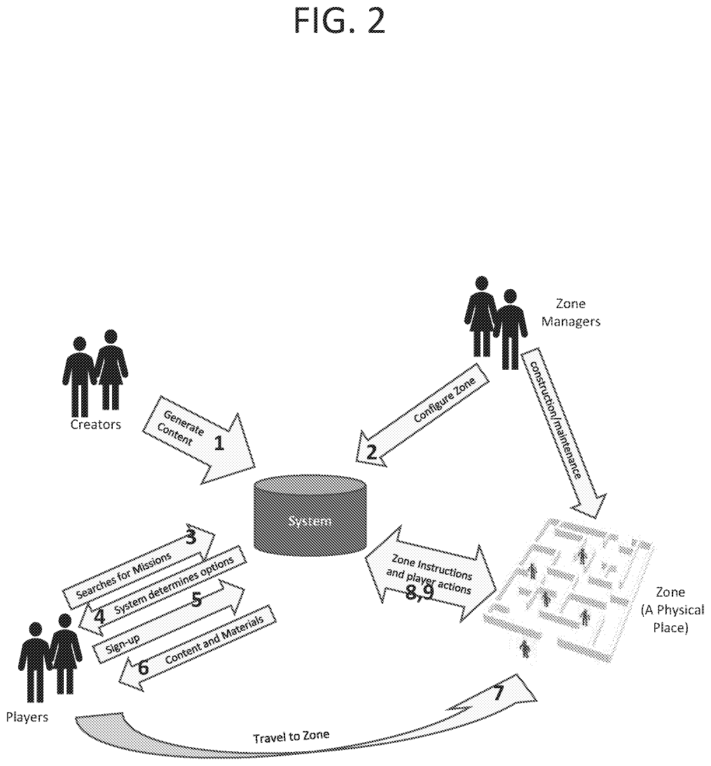

FIG. 2 is an exemplary schematic representation of the system 100 in FIG. 1 showing, schematically, the role of several particular types of persons (e.g., content creators 220, zone managers 222, and players 224) with respect to the overall system 100. In various implementations, some of these roles may be satisfied by the person interacting with one of the associated computer-based terminals and/or by performing one or more physical tasks (e.g., traveling to the physical zone 102 or constructing or maintaining the physical zone 102). Some of the numbers in the numerical sequence (1-9) suggest possible sequential relationships, but not necessarily.

At a high level, according to the exemplary implementation, the content creators 220 generate content (at 1). The zone managers 222 configure construct and/or maintain the zone (at 2). The players 224 search for missions (at 3). In this regard, the computer system 104 determines (and presents to the players) available options (at 4) for missions to undertake at the physical zone 102. The players 224 sign-up for one of the options (at 5). The computer system 104 provides content and/or other materials (e.g., training materials) for the selected mission to the players 224 (at 6). The players travel to the physical zone 102 (at 7). The computer system 104 interacts with the physical zone—with, e.g., zone instructions and player actions—at 8 and 9 while the mission is being undertaken.

Thus, in some implementations, the system 100 operates according to the following:
1. Content is entered into the system by creators;
2. Zone managers create a physical infrastructure and then register its characteristics in the system.
3. Player(s) want to use the construct of a mission for learning or entertainment purposes by engaging with the system. The player(s) selects a mission to undertake. The player(s), thereby, inherently, but not explicitly, expresses a desire for a particular type of zone as well.
4. The system determines if the selected mission can be executed in an available zone (e.g., it checks to see if all the necessary elements (e.g., number of rooms, components in each room, etc.) are present in an available zone.).
5. The player(s) signs-up for the mission (if the system determines that an available zone can support the mission).
6. The system engages with the player(s) (e.g., by sending training materials and/or other documentation that may be zone agnostic), typically in advance of the player(s) undertaking the mission.
7. The player(s) prepare for the mission and, when prepared, go to the zone to begin the mission.
8. The system configures and generates a set of commands that will manipulate and/or control the zone (including components therein) based on the selected mission and in response to player(s) actions in the zone.
9. The system may re-configure the zone or a part of the zone as player(s) move out of a room so that other player(s) may begin missions and utilize the relevant part of the zone.

These processes can be happening continuously and/or in an overlapping manner. While some are sequential, not all are pre-requisites for others. Further details of examples of each step are provided below.

### Step 1) Creating Content in the System

There are a variety of people that may want to create (and who may create) content for the system. Here are some examples:
Educators—Teachers can use missions as part of their teaching and school curriculum to help students learn a concept. The mission does not replace learning, but the act of physically performing an exercise that utilizes the lessons taught in class, will help students visualize the concept, know when to use it, and create vivid memories to remember it.
Parents—As parents get more ingrained in their kids' lives, they may think of missions that could teach concepts that their children struggle with.
Corporate L&D departments—Companies are trying to engage employees and make corporate training and orientation more interesting. By taking training concepts and forming them into missions, a company can enable their people to learn more and be more effective with their time.
Consultants—Corporate Training. The same concepts from Corporate L&D staff apply to consultants that work for big companies, often running multi-day workshops. They typically hold ‘mixers’, ‘ice breakers’, ‘simulations’ and ‘team exercises’ that could be the basis for a mission, thus allowing physical participation in these events and engaging attendees.
Consultants—Education. Consultants also work in secondary schools to either directly engage students with intricate programs (i.e. team building) or with teachers directly to help them learn new ways to teach and engage students. In efforts to make experiential learning more ‘real’ for these audiences, consultants might pre-emptively program Missions that fit the theme they are teaching, thus creating content for teachers to test with students.
Entertainment companies—Missions can also be purely for entertainment. A movie studio might create a series of missions (or quests) for the purpose of extending the experience of the movie-goer. A mission could complement the plot of the movie.
Freelance profiteers—The system can support a two-sided market. Mission creators could offer ‘rewards’ for solving their missions and receive a fee for each player that attempts to solve the mission. For example, a bank theft mission could be created where the creator places a sum of money in a ‘vault’ that the players have to try to steal. They pay a fee for each attempt and the creator gets a piece of that fee each time. If the sum of all of the players' fees is more than the reward in the vault, the creator makes money. There is an incentive to create missions and ever more challenging ones.

There are a variety of ways in which the content created by a creator may be entered into the system. In one exemplary implementation, the system may be configured to present a series of questions to prompt the content creator (at a computer-based content creator user interface) to enter the information necessary to fully define a particular mission. These questions may prompt the content creator to specify one or more of the following (list is not necessarily comprehensive):
Mission Name: Similar to a movie title, something to identify the mission.
Description: Language describing what the Mission aims to achieve, (e.g., the “sales pitch”).
Plot Line: The story forming the thematic backdrop of the mission. This may be a longer narrative than the description.
Status—This may describe how the system should process the mission (e.g., active, inactive, pending, etc.). In most cases, there would be a workflow for approval of a mission on the platform. Any missions that still require approval might be designated with an inactive or pending status. That way a creator would not be able to create a mission targeted at kids that includes inappropriate content, for example.
Lesson(s)—This may describe the lesson(s) that will, or should, be learned if the mission is completed (e.g., two variable algebra, a new corporate charter, a value statement, etc.).
Success Message—A success message is a message that the system will deliver (e.g., on a computer terminal or played over a speaker, etc.) if a player (or participant) completes a mission—typically, a congratulatory note.
Fail Message—A fail message is a message that the system will deliver if a player (or participant) completes a mission—in some implementations, these may be encouraging words to make the player want to try again.
Sponsor—This is the person or organization sponsoring a particular mission. If a corporation is sponsoring the mission, for example, and the content for the mission is company-confidential, a special link may be provided to limit training material access to employees of the company.
Resource Links—This may include internet links that point the player to training Materials that will include, or help them learn, what is needed (i.e., the skills or knowledge required) to accomplish the mission.
Skills needed—This may identify the skills needed to qualify players to embark on a mission (like course pre-requisites). These may need to have been mastered by the player before embarking on the mission. (e.g., Algebra 1, “to have read the company handbook”).

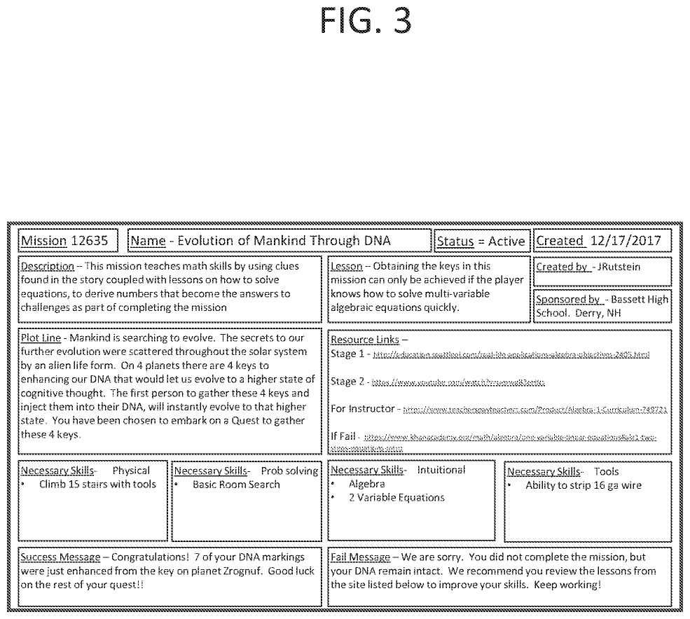

This, and potentially other information, may be saved by the computer system in a mission header, an electronic record that summarizes various features of a mission. A graphical representation of an exemplary mission header record is shown in FIG. 3. The illustrated mission header has a separate field for each piece of information entered by, or on behalf of, the content creator, for the mission. The illustrated mission header also has a field identifying a mission identification number, which is a unique number that the system uses to track the mission and its associated attributes.

### Missions

At the top level is the mission itself. The attributes that provides contextual information about the mission can be included in, and saved as, a mission header. As mentioned above, the mission header is a logical record that summarizes the overall characteristics of the mission.

### Objectives.

The second level of hierarchy in the construction of mission content can be referred to as the objective. Each objective generally relates to a single room in the zone. In short, something (an objective) must be achieved in the room before proceeding to the next room. That thing is the objective. In a typical implementation, the system:
1. Evaluates the objective's parameters and compares them to the parameters of a physical space (e.g., Room(s)) to see if they are a match. Thus, the system can automatically determine if a particular mission can be executed at a particular zone.
2. Utilizes the objective's parameters to set up the room as part of the mission's programming. In a typical implementation, if a tablet is to be used as the input device for that objective, the tablet should power on and load the appropriate screen. Or lights might need to turn on, or a motion sensor, etc.
3. Presents training materials and/or other content to the player(s). In some implementations, the system interprets the content of the objective for presentation to the player(s). In the crypt example, there could be hieroglyphics or some code that was entered as part of configuring the mission. It would need to be ‘interpreted’ and (since it is text) displayed, for example, on a large TV screen, so that the player(s) could see it and try to decipher the code. In the future this could be a holographic rendering of an image. In a typical implementation, a player cannot solve a mission without completing each objective. In order to solve the challenges for an objective, he or she generally must understand the attributes of (e.g., training materials associated with) each objective.

There are a variety of ways in which the objective and objective attributes may be entered (e.g., by a creator) into the system. In one exemplary implementation, the system may be configured to a present a series of questions to prompt the content creator (at a computer-based content creator user interface) to enter the information necessary to fully define particular objectives. These questions may prompt the content creator to specify one or more of the following (list is not necessarily comprehensive):
Objective name (e.g., a title for reference “solve for code to unlock door to get to the next Room”)
Room Type (e.g., Office, Conference Room, Storage Closet, Computer Room, Etc.)
Objective Description (typically, a longer description than the objective name to assist the player(s) understand the objective in context)
Room Size and aesthetics (e.g., size of room (e.g., at least 10×15 feet), shape of Room, etc.)
Room Mood settings (e.g., air, sound, features on the wall, and images in the room)
Room Specific Items and Placement (e.g., location of items like desks, chairs, sofas, cabinets)
Devices required. These are derived from the underlying tasks detailed in the next section (e.g., computer, keypad, touchscreen, etc.)
Time for Objective (e.g., 13 minutes max)
Number of Players for objective (e.g., 1 to 3)
Prerequisite objective(s) (e.g., must have completed x before this objective)

This, and potentially other information, may be saved by the computer system in an objective information record, an electronic record that summarizes various features/attributes of an objective. The objective information record also may have a field identifying an objective number, which is a unique number that the system uses to track objectives and their associated attributes. An exemplary objective number might be (e.g., the unique identifier=62).

### Tasks.

The lowest level of the hierarchy can be referred to as the task. In an exemplary implementation, a task is an action or actions that must be performed to yield a result, which can be submitted to the system for evaluation of correctness. Tasks may be performed within, and as part of, an objective, but need not be exclusive to that objective. Generally speaking, a particular task can only be performed if the room associated to that objective has the requisite components. For example, a creator should not configure a task to perform a math problem and enter the results on a keypad, if the objective is linked to the room type where the task is to be performed has no keypad. A player has to have the opportunity to complete the task, and if not, there should be a reason why and alternative path in the mission's programming.

Tasks also have attributes. The task attributes generally enable the system to engage the player with specific things to do. These things that the player must do then become the base level governing step for the system to determine if the player is progressing through the mission. Some examples of task attributes are listed below. Some of these task attributes may be entered into the system by the creator and stored by the system as an electronic record. The task number may be an arbitrary or sequential number, for example, that is assigned by the system to identify the associated task (and its task attributes). This list is not exhaustive.
Task Number (i.e., a unique identifier e.g., =101)
Name (e.g., a title for this item “Get First Number from the Tomb”)
Description (A description that tells the Player what she should be doing in the Task)
Preparation Steps (e.g., review process on web page xxx 1 week before the Mission)
Time total (e.g., sum of time in green status and time in yellow status)
Time in Green status (e.g., 3 minutes)
Time in Yellow Status (e.g., 1 minute)
Time Warning Message (e.g., “YOU HAVE 1 MINUTE REMAINING”)
Task Hint (e.g., “Try looking under the laptop . . . ”)
Time Fail Message (e.g., “Time is up, Mission Over”)
Is Response required (Y/N, some Tasks might require the Player to do something but not submit a challenge response)
Challenge Response Correct Value (e.g., 364)
Challenge Response Device (Keypad, Cell Phone, Touchscreen, etc.)
Number of submissions allowed (e.g., 3)
Submission Warning Message (e.g., “Incorrect. Try again”)
Submission Fail Message (e.g., “Too many incorrect answers. Mission Over”)

### How is a Mission Constructed in the System?

In a typical implementation, a mission may be created by creating a mission header, which provides an overall theme and story for the mission and then adding objectives and tasks to the mission (e.g., creating logical links between certain objectives and tasks and the mission). The system, in this regard, may provide an interface at a computer-based user interface that is accessible to the creator constructing the mission. The interface can have any one of a variety of different formats and can facilitate creating the logical associations in a graphical environment or textual environment.

Because they are in a hierarchy, objectives and tasks might already exist, or they can be created on-the-fly. The system, in a typical implementation, will make available to the creator (e.g., at the creator's computer-based interface) a listing or identification of previously-created objectives and tasks, if any. In some implementations, these previously-created objectives and tasks may have been created previously by the creator who is currently engaged with the system. In some implementations, these previously-created objectives and tasks may have been created previously by someone other than the creator who is currently engaged with the system.

If a desired objective or task already exists in the system (e.g., it has already been created and saved in the system), the creator may simply select that objective or task (rather than having to recreate it) to add it to the mission being created.

Each of the items in this hierarchy is independent of the other; however components can be reused as often as are needed for creating missions. In one example, the structure of a mission can be represented in hierarchical structures that indicate associations in the system between the associated items (e.g., missions, objectives and tasks).

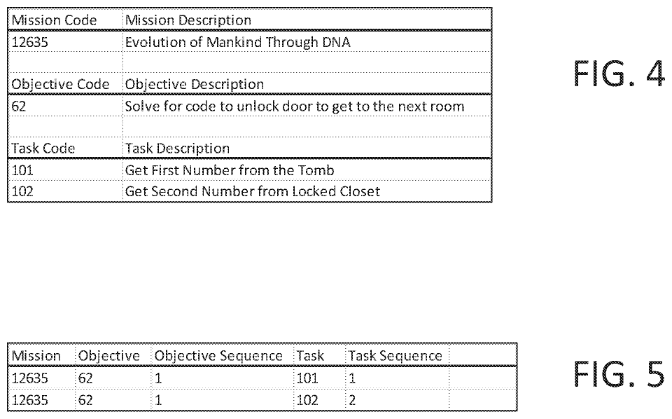

FIG. 4 and FIG. 5 respectively show hierarchical structures of items (e.g., a mission, an objective, and tasks) that have been associated with one another in a system, essentially to define a mission.

To produce the indicated hierarchical structure (in FIG. 4 and FIG. 5), for example, a creator (at one of the computer-based creator terminals) may create, or select from a listing or previously-created tasks, task 101 (“get first number from the tomb”) and task 102. (“get second number from locked closet”). In this example, the task numbers (101 and 102) may indicate a required performance order, such that successful completion of the associated mission would require completing task 101 (“get first number from the tomb”) before completing task 102 (“get second number from locked closet”). In some implementations, the system determines (e.g., by processing the description of these tasks) that a “tomb” needs to be present in a zone to accommodate task 101, a “locked closet” needs to be present in a zone to accommodate task 102, and both (a “tomb” and a “locked closet”) needs to be present in a zone to accommodate both tasks (101 and 102). Creating these tasks (101 and 102) generally includes entering into the system (e.g., in response to prompts by the system) the relevant task attributes needed to fully specify the tasks.

Next, in this exemplary implementation, the creator creates an objective (62). The creator also creates a logical association in the objective to the indicated tasks (101 and 102), which means that the objective (62), in practice, should include the indicated tasks (101 and 102). In the example represented in FIG. 4 and FIG. 5, the objective has an objective code of 62 and is entitled, “solve for code to unlock door to get to the next room.” At this point, in some implementations, the system has determined that a logical link exists between objective 62 (“solve for code to unlock door to get to the next room”) and the two tasks (101, “get first number from the tomb”) and (102, “get second number from locked closet”). Additionally, the system, in some implementations, determines (e.g., by processing the description of the objective) that a room with a lockable (and unlockable) door needs to present in one room of the zone to accommodate the indicated objective (62). Moreover, the system, in some implementations, determines (e.g., by processing the logical association between objective 62 and tasks 101 and 102, and the descriptions thereof) that the room (with the lockable and unlockable door) also needs to have a “tomb” and a “locked closet” in the room to accommodate logically associated tasks 101 and 102 as part of the objective.

Next, in this exemplary implementation, the creator creates a mission (12635) and creates a logical association between the mission (12635) and the objective (62), which is already logically associated with tasks 101 and 102. This means that the mission (12635), in practice, should include the objective (62) and the associated tasks (101 and 102). In the example represented in FIG. 4 and FIG. 5, the mission has a mission code of 12635 and is entitled “Evolution of Mankind through DNA.” At this point, in some implementations, the system has determined that a logical link exists between mission (12635) and objective (62), such that the objective “solve for code to unlock door to get to the next room” (and the two associated tasks 101 and 102) will form, at least part of the mission (12635).

The table in FIG. 5 includes data that may be entered, or selected, by a creator creating a mission (12635). In particular, the mission (12635) represented in the table includes one objective (62), which is sequentially the first (and only) objective (as indicated by the “objective sequence” column) to be undertaken as part of the mission (12635). The mission (12635) and the objective (62) have two tasks 101 and 102, of which, task 101 is to be performed first, and task 102 is to be performed second (as indicated by the “task sequence” column).

A combination of the base data in FIG. 4, plus the linkage logic in FIG. 5, can generate the following mission hierarchy:
Mission 12635—Evolution of Mankind through DNA
   Objective 62—Solve for code to unlock door to get to the next Room
      Task 101—Get First Number from the Tomb
      Task 102—Get Second Number from Locked Closet

This sort of construction facilitates creators being able to leverage content created by others. For example, a new Mission, #12701, could use objective 62, but instead gather the numeric values for solving the equation from somewhere other than the locked closet. In that case there might be a “task 103—Get second number from ornate chest”, which could be used to generate the following Mission hierarchy.
Mission 12701—Phase 2 evolution, Chromosomes 12-13
   Objective 62—Solve for code to unlock door to get to the next Room
      Task 101—Get First Number from the Tomb
      Task 103—Get second number from ornate chest

Nearly infinite amounts of content, and combinations, can be stored in the system, using this architecture.

### Step 2) Zone Managers Create the Physical Infrastructure and Configure the System

In order for a physical space to become a zone (that can support a mission) and thus controllable by the system, the characteristics of the space need to be entered (registered) into the system. In a typical implementations, these characteristics use the same words (or attribute qualifiers) to describe the space and the devices (components) therein, as when missions, objectives and/or tasks, are created and entered into the system built. For example, the system may use the same room types and names of devices when entering (or registering) devices in a room as used to specify room types and devices needed when creating a mission.

Thus, in a typical implementation, the zone manager may build a zone that has certain parameters and enter those parameters into the system using words that are the same as (or highly similar to) the words used by the creator in specifying a mission. This enables the system to easily link missions to physical zones, based on common parameters.

In some implementations, a zone will have multiple rooms linked by doors, connectors, tunnels, etc. In general, each zone should be identified in the system (e.g., by a zone manager) with a name. Each zone should be identified in the system (e.g., by the zone manager) as having a certain number of rooms within the Zone. Moreover, each zone should be identified in the system (e.g., by the zone manager) as having a certain number of and type of devices within each room.

In an exemplary implementation, a zone/room/device hierarchy could look as follows. The device in this example could be an item that interacts with the system's program and is controlled in accordance with parameters of the mission.
Zone—“Neon Office Park”
   Room 1—“Lobby”
      Device1—Main Desk
      Device2—CardKey swipe and turnstile
      Device3—Digital screen with Directory of companies list
      Device4—Door to “Corporate Office”
      Device5—Door to “Elevator”
      Device6—Light
   Room 2—“Corporate Office”
      Device7—Desk
      Device8—File Cabinet
      Device9—Door to “Lobby”
      Device10—Light
   Room 3—“Elevator”
      Device11—Digital Keypad
      Device12—Door to “Lobby”
      Device13—Light

Each zone may have a series of attributes. These attributes may be used, for example, for administrative purposes. Adding rooms to a zone could change the mission capabilities of that zone. Typically, missions are applied to zones based on operational attributes from lower levels; not zone level attributes. These are some exemplary zone level attributes that a zone manager, for example, may enter into the system for a particular zone.
Name
Address
City
State
Zip
Owner of site
Manager name of the site
Total square feet
Number of Rooms
Etc.

Each room also has attributes. In some implementations, these attributes, combined with the device registrations, enable the system to determine if a mission can physically execute at a zone that has these rooms. In an exemplary implementation, two algorithms (described later) enable the system to make this determination. The mission specifies a required room type (in the objective). When a zone is configured in the system, each room is categorized by room type. If those two match, the mission can be executed. And further, they provide the communication mapping to the zone. For example, a device's address is a unique way of identifying that device across a network (e.g., the Internet). It can send and receive signals from a system (commonly referred as Internet of Things (IOT)). Because that unique address is associated with a room, and the room to the zone, when the mission begins at a zone, the system knows all of the devices that will be utilized for that mission. It will need to send signals to each of these devices. As an example, to start it will lock the doors, turn on lights, load a page on a tablet, display an image on a TV. The doors, lights, tablet and TV are all devices that have unique addresses and are needed by the mission (in one example) to execute. The tablet is one device that will send a signal (a challenge response) back to the system. Because it has an address registered and associated with the mission, the system knows to receive that message and evaluate as part of the mission. Typically, the room is ‘coded’ or ‘registered’ by the system so that the system knows that once a room is ‘active’ or the player is in that room solving the objective, that all the devices associated with that room, are also active. In one example, if a mission starts at a zone, the zone's rooms may all have coding and devices in them with individual system-wide addresses so that a command instruction can be sent by the system directly to the device. Thus, the system can control the operations of the zone (including the operations of the devices within the zone) based on the parameters of a mission that is being executed. These are some exemplary room level attributes that a zone manager, for example, may enter into the system for a particular room (the room number may be assigned by the system, not by the zone manager).
Room ID (a numeric code)
Room Name (even though multiple rooms in a zone might have the same room types, each individual room should have a unique name)
Length (e.g., 10 feet)
Width (e.g., 16 feet)
Height (e.g., 10 feet)
General Shape Type (e.g., “L” shape, “T” Shape, rectangular, round, etc.)
Room Type (e.g., Office, Conference Room, Crypt, BathRoom, Storage Space)
Room color tone (e.g., Dark, Light)
Etc.

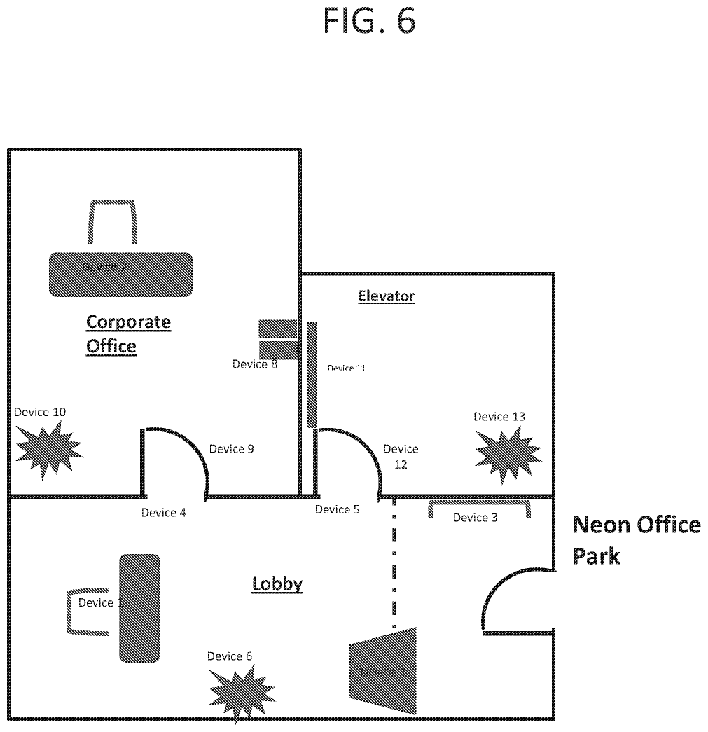

FIG. 6 shows a sample floorplan of a zone (i.e., Neon Office Park) with rooms and components (devices) in those rooms. The “rooms” represented in the illustrated floorplan include a lobby, a corporate office, and an elevator. The components (devices) in the lobby include device 1, device 2, device 3, device 4, and device 5. The components (devices) in the corporate office include device 7, device 8, device 9, and device 10. The components (devices) in the elevator include device 11, device 12, and device 13.

Step 3) A Player wants to engage with the System

There are several ways that the player might engage with the system; two options are described herein.

Option 1) A player (at a computer-based terminal) can select or identify desirable attributes for a mission. In this regard, the player might, for example, search or scroll through a list of attributes available in the zones of the system to find a mission to undertake. In this regard, the system may present to the player a search box that the player can enter an attribute or key word related to an attribute (e.g., a lesson to be taught, a skill needed, a style of mission, etc.) that the system will search for. Once the search is completed, the system may present a listing of search results—i.e., missions that have attributes, or associated objective attributes, or associated task attributes that match the or are related to the key word.

Alternatively, the player might search for a particular zone, or indicate to the system which of the available zones is most desirable. The most desirable zone might be, for example, the one closest to the player. As an alternative example, if the mission might require a longer preparation time and the gathering of knowledge, the learning of skills and/or the assembling of materials needed for the mission, a location farther away might be acceptable. Each zone might not support a desired mission, so extending the search areas might be warranted.

Option 2) Instead of individually searching, a player may also engage with the system as a result of other channels, where a mission might have been recommended to them directly. For example:
an employer could recommend a training mission based on that employee's skills, new position in the company or intended career path,
an employer could build one or more missions to facilitate “new employee orientation” that an employee might work through at his or her own pace,
a friend could recommend a mission to another friend,
a friend could challenge other friends to “match” their accomplishment with respect to one or more missions,
a friend could recruit a player as part of a larger quest where different players simultaneously complete different missions for the benefit of (or as part of) the quest,
a teacher could create and assign missions as part of a taught curriculum (e.g., upon reaching a certain point in the course, the instructor might assign the mission like homework),
an entity could use the mission test to filter membership to a group (e.g. one can join when they complete . . . )
any person with access to the system can create a mission and offer a reward for completion. Those paying to accept that challenge would create income for the mission creator. The creator in this example takes the risk that player generated revenue might not outweigh their investment in the reward.
a company could use a mission as part of marketing. For example, an ‘open house’ that aims to educate potential customers could use a mission to teach players (participants) about the company, its product(s), and/or its product(s) features,
a company could use a mission for customers to train on software, a platform or other products. Here, the solution to a challenge (task), for example, might be completing a task on the new software platform.

In some implementations, the system facilitates communication between different users (e.g., any of the people identified above) about missions and how they might be utilized.

### Step 4) The System Determines Suitability

In a typical implementation, the system is configured to determine suitability of each particular zone to support each particular mission.

In some implementations, the system is configured such that it can identify to users (e.g., potential players (participants), content creators, etc.) which zones can support a desired mission, objective, or task. Moreover, in some implementations, the system is configured such that it can identify to users (e.g., potential players (participants), content creators, etc.) which missions, objectives, or tasks can be performed at a desired zone.

In this regard, the system may present to the user (e.g., at one of the computer-based user access terminals) an interface that provides searching capabilities (for zones can support a desired mission, objective, or task, or for missions, objectives, or tasks can be performed at a desired zone, etc.) or that lists combinations of compatible zones, missions, objectives, tasks, etc. that are available across the system. Of course, a single system may include multiple different zones that have or that can support multiple different missions, objectives, and/or tasks.

Generally speaking, a mission configuration necessitates certain requirements of a zone for it to be operational at that zone. It is possible that a zone might not support the requirements of a mission based on rooms, devices, sizes, shapes, availability, etc.

In a typical implementation, the system includes processing that is intelligent enough to leverage one or more algorithms that can determine, for example, the requirements of the mission and then dynamically derive which zones are capable of executing that mission. This suitability query (algorithm) may happen, for example, in real time as the player researches missions. An example of this algorithm is described below.

### Algorithm Logic

1. First a player selects a mission that he or she wants to undertake. The player may do this, for example, by selecting a desired mission from among a listing of missions available on the system.
2. Next, the player selects a desired zone. The player may do this, for example, by selecting the desired zone from among a listing of zones available on the system presented to the player at a computer-based user interface.
3. Each mission has one or more associated objectives. Each objective is tagged in the system (e.g., logically associated) with a room type. In response to the player's mission selection, the system may determine if the player's selected mission has room types that are present in the desired zone. This determination may be made by comparing key words from the stored room descriptions associated with the selected mission to try to find a match (or substantial match) to stored room descriptions associated with the selected zone. If the system determines that the player's selected mission has room types that are present in the desired zone, then the system can make further determinations of feasibility. If not, then the system may inform the player that the selected mission is not available at the selected zone, and allow the player to continue searching for or selecting other mission/zone combinations.
4. If (in step 3) the system determines that it should make further determinations of feasibility, it may proceed as follows. Each objective has one or more associated tasks. If a task requires a value to be submitted to the system for evaluation, for example, that task will also specify a device to facilitate system communications. The system, in that instance, can determine if the zone's rooms have the device(s) required to facilitate the system communications. Note: Not all devices are room specific. Some, like a mobile phone, may travel with the player as he or she travels through the mission. If the system determines that the zone's rooms do not have the device(s) required to facilitate the system communications, then the system may inform the player of this fact, and allow the player to continue searching for or selecting other mission/zone combinations.
5. In some implementations, if both determinations above are met, the system certifies that the request to begin the selected mission at the selected Zone is valid. The system then may allow the player to “sign-up” for the mission, and begin the process of preparing for and scheduling the mission as dictated by the mission's protocols.

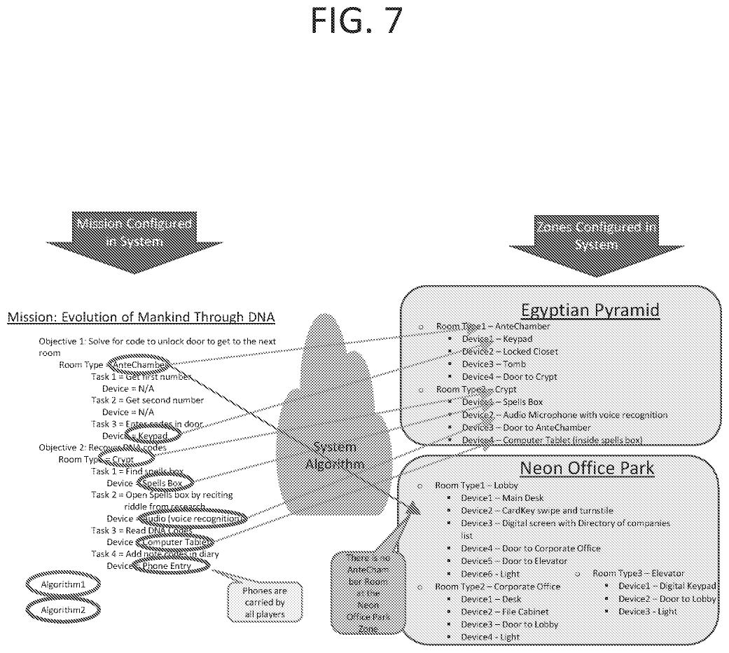

FIG. 7 is a graphical depiction of an exemplary system's algorithm(s) assessing room type/device to zone feasibility.

The exemplary depiction represents mission configuration information, for one mission (Evolution of Mankind Through DNA) on the left side of the page (with information about the represented mission that would be saved in the system), and zone configuration information, for two different zones (Egyptian Pyramid and Neon Office Park) on the right side of the page (with information about each respective one of these zones that would be saved in the system).

The system, in the illustrated example, would apply the system algorithm (represented centrally between the mission configuration information and the zone configuration information) to determine whether the indicated mission (which may have been selected by a user, for example) is able to be undertaken at either or both of the represented zones.

According to the illustrated implementation, the system applies two algorithms 1 and 2 (or two parts of an algorithm) to make this assessment. According to the first algorithm (algorithm 1), the system checks to see whether each of the room types (AnteChamber and Crypt) are available in either or both of the zones. As can be seen, of the two available zones, only the Egyptian Pyramid has both of the room types. Next, in algorithm 2, the system checks to see whether any devices are required by tasks associated with each room type. In this check, the system determines that the antechamber represented in the mission configuration information requires a keypad, and that the antechamber represented in the zone configuration information has a keypad. In this check, the system also determines that the crypt represented in the mission configuration information requires a spell box, an audio (voice recognition) device, a computer tablet, and a phone, and determines that the crypt represented in the zone configuration information has the requisite spell box, an audio (voice recognition) device, and a computer tablet, and that phones are carried by all players.

Therefore, in the illustrated example, the system concludes that the selected mission (Evolution of Mankind Through DNA) can be supported by the zone (Egyptian Pyramid) represented in the zone configuration information. In a typical implementation, the system would present a message to the player (e.g., at one of the computer-based user interfaces) indicating that the mission could be accomplished at the zone and prompting, or enabling the user to sign up to undertake the mission at that zone.

### Step 5) Players Sign-Up for a Mission

There are a variety of ways in which players may sign-up for a mission. According to one exemplary implementation, signing-up for a mission could be as simple as just selecting an icon and/or clicking an “accept” button. In a typical implementation, when signing up, the player might be prompted to provide some contact information and a method of paying for the mission.

After signing-up, in some implementations, the mission parameters (e.g., all or several of the attributes associated with the mission . . . name, description, plot, objectives, tasks, etc.) essentially take over. For example, the mission parameters might cause the system to communicate with the player around the need for the player to prepare, train and/or gather material in anticipation of the mission. As another example, the mission parameters might cause the system to start with the timer counting down to when the player will need to enter the zone and begin the mission. In the latter case, the cycle may be abbreviated and steps 6 and 7 in FIG. 2 may happen in very short order if not simultaneously. No matter which structure, the system may begin interacting with the player and controlling the physical space where the zone is located, at least by the time the player(s) enters the zone.

In a typical implementation, the system records this event in a database in the system's computer-based memory storage. In some implementations, the start of a mission is recorded to enable several functions performed by the system. This may trigger a billing event to charge the player for beginning a mission, it may log that transaction to keep track of player progress, it may log the start of the mission, and it may help keep track of leveling or skill points associated to the mission and conveyed to the player upon completion.

Step 6) The System Engages with the Player

A mission is broken down into objectives and tasks (that include some challenges to be completed and responses to be submitted to the system for evaluation). These may require some preparation by the player(s) including, for example, reviewing the mission plan, gathering materials, accumulating knowledge (training), rehearsing, recruiting other platers, etc.

In general, simpler tasks tend to require less preparation, whereas more complex tasks tend to require more preparation. For example, looking for a number in a box (a relatively simple task) may require only reading that the player will need to look for a box. As another example, if a task will require calculating a ratio (a relatively more complex task), the player may need to learn about ratios and perhaps how to use a calculator to calculate a ratio (more significant preparation).

Each mission may include a variety of tasks having varying levels of difficulty and complexity, and, accordingly, requiring different levels of preparation by the player(s) before beginning the mission at the zone. In general, the specific combination of tasks included in a mission will dictate how much lead time and preparation may be needed for a mission. In some implementations, as part of configuring a mission, the creator can stipulate the number of days before mission execution that training materials should be sent to the player.

There are also options for more complex tasks. Consider the Task to “Open the spell box” for example. In this case, there might be an archeological text that contains the passage to be recanted when on the Mission (evaluated by a voice response engine). Research is required to find this text, write it down or memorize it. In that case, the Mission begins before the Player is at the Zone to perform the physical Tasks, they are instructed with emails, links, texts or other communication vehicles on how to find the passage.

There might also be a learning exercise to illustrate an understanding of a mathematical theorem (e.g., the Pythagorean Theorem). In general, this would need to start well before the physical mission activities begin. As an example, an objective for a room might be to get one shot at pressing the ‘security system deactivation button’ on a wall. But the only way to access the room is to enter through a ceiling vent. The lesson for the room would be to use Pythagorean Theorem to create a pendulum to press the button with a ball on the end of a string from the open ceiling vent. This is a multi-step and complex process that would require significant prep work (by the player(s)).

The preparation that might be required in the foregoing example can include in this case, the system presenting to the player(s), before the mission begins, materials on how the Pythagorean Theorem works. The player may also need to research the dimensions of the walls and ceiling to determine the lengths of A and B in Pythagorean Theorem. Then they solve for C. Finally they would prepare a string and ball with properly measured length to carry into the mission.

All of these activities related to preparation, learning, assembly, and coordination are part of the system and its control of the components needed to complete the mission. In a typical implementation, these activities involve and may be facilitated by the system. The mission creator knows each task, and thus knows what materials and knowledge are needed to solve the task. Thus by the creator entering attributes (links, documents and other learning materials) into the mission information, the system can disseminate those materials as a prerequisite of accomplishing the mission.

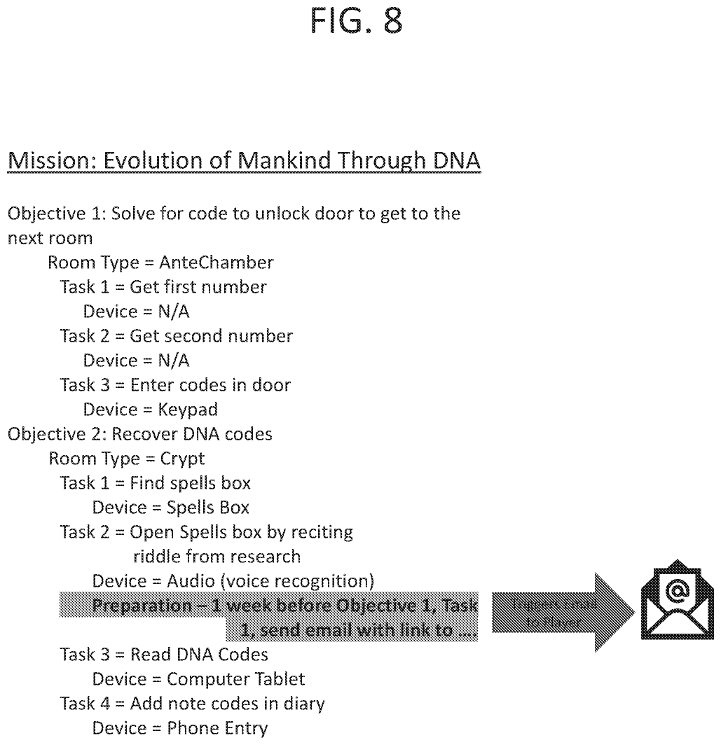

FIG. 8 is a schematic representation of a mission (evolution of mankind through DNA), which includes an indication that the system derives and acts upon a preparation parameter dictated by task 2 in the crypt (“open spells box by reciting riddle from research”). In some implementations, this task, when created, will have been tagged (by its creator) as requiring some form of preparation. More specifically, in this example, the creator may have entered a preparation parameter associated with the task indicating that the system should send an email to the player(s), at a designated time before the mission is undertaken, that includes a link to information that will be relevant to the player(s) being able to open the spells box by reciting a riddle from research. In the illustrated example, the system is able to determine, from the preparation parameter associated with task 2 in the crypt that email should be sent to the player(s) 1 week prior to the mission date. The system is further configured to send the email automatically at the designated time to the player(s) that will be undertaking the mission.

### Step 7) Player Prepares for the Mission

In a typical implementation, once the player starts receiving preparation details from the system (e.g., via email, text, push notification, etc.) to complete a Mission, he or she can begin preparing. The system, in this regard, will have communicated to the player(s) by executing on any instructions that were configured and entered into the system by the creator.

In a typical implementation, it is the creator's responsibility to design a mission in a comprehensive way, so as to have thought out all processes necessary to facilitate a learning or entertaining experience for the player(s) that is highly engaging. The focus is on real world execution and the behavior of a person or group of people moving through a physical space, engaging with that space as they proceed. In some instances, it will behoove the creator to devote a comparable amount of care to good mission design, as would be accorded to the making of a movie, or at least a good classroom academic lesson.

In a typical implementation, it is the player's responsibility to read, understand, and follow-up on the materials transmitted to them and to do the actual preparatory work for a mission. In a typical implementation, the players should have learned any materials, planned an approach to the mission, and gathered any equipment necessary to complete all mission tasks prior to beginning the mission. This may include, for example, each player coordinating with any others (e.g., other players) that may be necessary for the mission's successful execution. Others may include, for example, partners in the same mission zone, partners operating at another zone simultaneously, partners operating with pre-requisites or follow-up missions, and/or support personnel helping any of these groups from behind the scenes.

There are several circumstances under which a player might coordinate with someone doing a different mission. For example:
Same Zone—Multiple players might need to complete tasks in different rooms at the same time.
Another zone—Zones could be based on theme. One a crypt, one a pyramid. A more complex mission or quest could require secret keys discovered in the separately thematic zones for use in a 3^{rd} zone themed after a treasure room.
Pre-requisites—It might be necessary for a player to plant a bug to gather intelligence remotely for use in a mission several days later.
Support personnel—A handler back at a ‘home base’ might be required to help coordinate hacking of a security system to assist the player in breaching a room.

After preparation, at the designated mission time, the player goes to the zone.

At the zone, the player starts the mission. In a typical implementation, starting the mission also triggers the start of a timer clock—to track how much time is remaining for the mission. Starting the mission also generally kicks off the next steps of the mission's program within the system.

In a typical implementation, all of the objectives and tasks will be configured with a particular sequential order. Therefore, the system, in a typical implementation, will know which objective and task to queue first, and which results it should expect to receive first.

### Step 8) the System Generates Commands to Manipulate the Zone

In a typical implementation, the system is configured to interact with and control various components (e.g., physical components, electrical components, optical components, etc.) within the zone to create a satisfying mission experience within the zone.

As mentioned above, in a typical implementation, all of the objectives and tasks will be configured with a particular sequential order. Therefore, in a typical implementation, the system will know the order in which the objectives and tasks should be executed and can control the various components during mission execution to facilitate and react to the ordered execution of the objectives and tasks. For example, when a mission begins, the system will know the first objective of the mission and the first task of that objective. The objective and task will take place in a particular room within the zone. Therefore, the system configures that space according to preprogrammed parameters (specified by the creator) to make that room ready for the first task of the first objective to happen. The system enables the player to engage with that room, by including devices in the room that are required by the mission to enable interactions by the player.

In exemplary instances, the system may configure a particular room (for a particular task of a particular objective), by causing one or more (or all) of the following to happen (this list is not exhaustive):
Lights dim, turn off, turn on, change color, flash, or react to movement,
Motion and pressure sensors engage,
Laser sensors turn on,
Audio equipment begins to “listen,”
Sound equipment generates music or other audio as part of the mood,
Doors open into the room, other doors lock,
Objects in the room move into place for the mission (e.g., a box could move to where it needs to be for the mission or a movable wall slides to obscure something meant to be hidden),
Video screens turn on and display images,
Holographic image generators start generating 3D images,
Fans blow wind and scents (from scent dispensers) around the room,
Buttons illuminate around the room, and/or
Some objects that require motion as part of the challenge turn on and begin their individual patterns.

In various implementations, a room that can support the system performing these sorts of configurations might include any one or more (or all) of these devices (components): lights, a light dimmer and switch, different color lights, flashing lights, motion sensors (that may be configured to cause a light to react), pressure sensors, laser sensors, audio equipment (e.g., microphones, etc.), sound equipment (e.g., speakers), doors, doors locks, objects in the room (e.g., boxes, furniture, etc.) that can move, walls, movable walls, video screens, holographic image generators, fans, scent dispensers, buttons or other objects that can illuminate, etc.

Moreover, the room (or a space around the room) may include one or more actuators that receive control signals (e.g., from the computer-based processing and memory system) to facilitate control (in accordance with mission information provided by the creator) of and/or to turn on or off any of the lights, light dimmers, switches, colored lights, flashing lights, motion sensors, pressure sensors, laser sensors, audio equipment (e.g., microphones, etc.), sound equipment (e.g., speakers), doors, doors locks, objects in the room (e.g., boxes, furniture, etc.) that can move, movable walls, video screens, holographic image generators, fans, scent dispensers, buttons or other objects that can illuminate, etc.

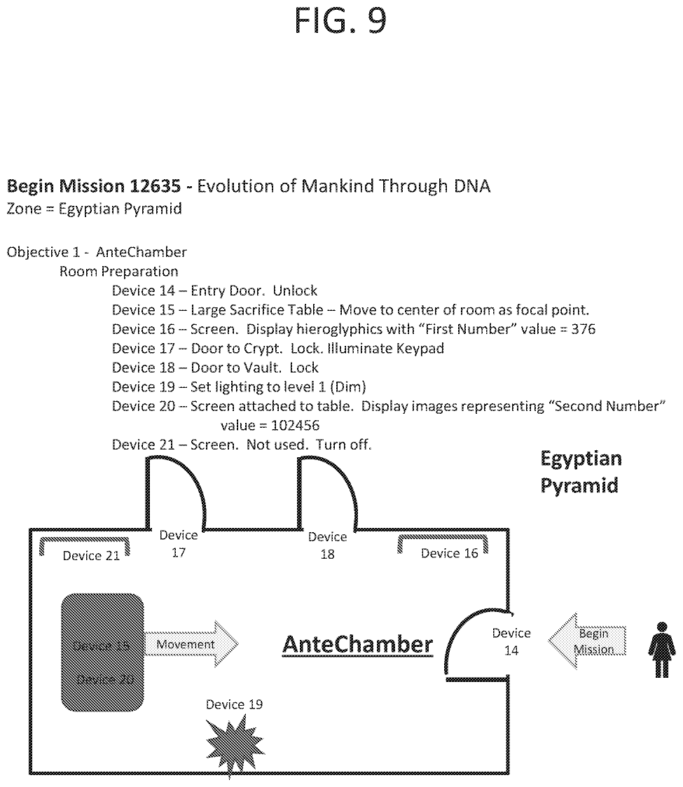

FIG. 9 shows an example of how a system might set up or configure a room (Antechamber) in a zone (Egyptian Pyramid) to make the room ready to support a particular objective (Objective 1).

According to the illustrated example, the room has eight different devices: device 14 (entry door), device 15 (large sacrificial table), device 16 (screen), device 17 (door to crypt), device 18 (door to vault), device 19 (lights), device 20 (screen attached to table), and device 21 (screen). According to the represented configuration, the system provides signals (e.g., to actuators) that cause device 14 (entry door) to unlock, device 15 (large sacrificial table) to move to a center of the room as a focal point, device 16 (screen) to display hieroglyphics with a “first number” value of 376, device 17 (door to crypt) to lock and have its keypad illuminated, device 18 (door to vault) to lock, device 19 (lights) to set a lighting level in the space to 1 (dim), device 20 (screen attached to table) to display images representing a “second number” value of 102456, and device 21 (screen) to off (because, in the selected objective, this device will not be used).

After the system sets up a room to support an objective, and the player starts moving through the room to pursue the objective, the system may interact with the player and/or make changes to the room as the player interacts with the devices. For example, if the player interacts with a configured device in the room, which results in the device submitting a challenge response from the player into the system, then the system may react by causing another action to occur (e.g., through another device in the space). For example, if the player enters a code that he or she figured out into a keypad for a door, then, when the system receives the code and confirms that the code is correct, the system may cause a lock on the door to unlock. There are various other (some much more dramatic) actions that the system may be configured to cause in response to either correct or incorrect action by the player in the zone.

Some actions (e.g., simply gathering the two numbers in the AnteChamber) are not challenge responses to the system through devices. In these cases, the devices may be controlled by the system, but generally only as conveyors of information or to prompt a player's action(s) within the room (e.g., to look at a particular screen).

Some actions, however, (e.g., the entry of a calculated code to open a door), is a challenge response. Upon typing the calculated code value into the keypad at a device (e.g., the keypad of device 17 in FIG. 9), the system evaluates that Response, sees that it matches the correct value that was entered by the creator and stored as part of the mission configuration information, and unlocks the door as prescribed. In this case, device 17 is gathering information from the player, enabling the system to react to it, and then manipulating the behavior of the space, based on that response. The device could have set off alarms for an incorrect response, or moved the table, based on the response, or ended the mission experience for an incorrect response, etc.

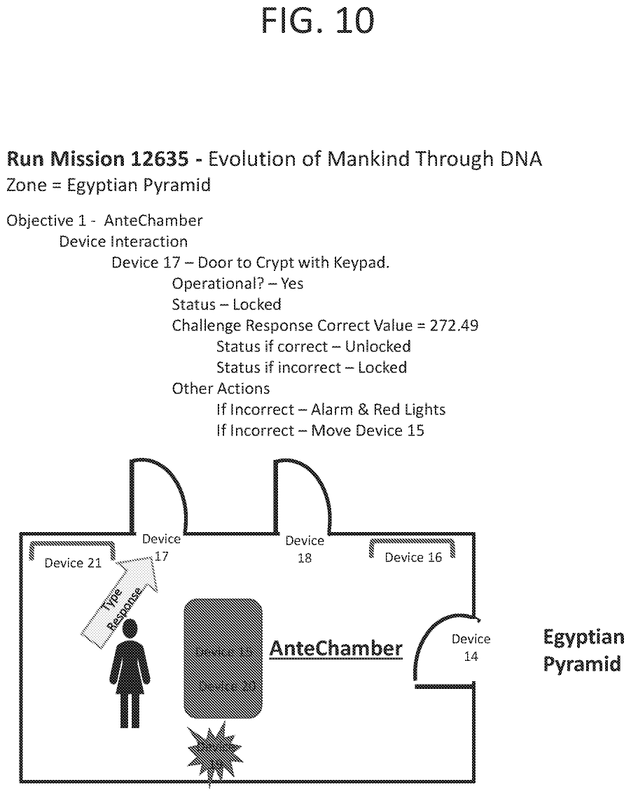

FIG. 10 is a schematic representation showing an example of the behavior of a device (device 17, a door to the crypt with a keypad) within a zone (Egyptian Pyramid) within the context of completing an objective (AnteChamber). The example represented in the illustrated figure is indicative of how the system might respond to a player's interactions with device 17 while pursuing the objective in the room. In a typical implementation, the information represented in the illustrated figure will have been entered into the system by the creator.

As indicated, the device (device 17, a door to the crypt with a keypad) is operational, which, in this example, means that the door can be opened or closed and can be locked or unlocked (e.g., using the keypad). The starting state of device 17 is locked. Therefore, when the player interacts with the door during a mission, if successful, the player might unlock the door. In particular, the player, in the illustrated example, provides a response to a challenge (e.g., by entering a code into the keypad). The correct value of the code, as shown (and as would have been specified by the creator during mission configuration) is 272.49. According to the logic represented in the figure, if the player provides the correct response, then the system causes the locked door to unlock. According to the logic represented in the figure, if the player provides a response that is not correct, then the system leaves the door locked, but causes other actions in the room to occur—namely, an alarm to sound and red lights to come on, and device 15 to move.

In a typical implementation, processes similar to the one described above continue for each objective/room and task interaction for the entire mission or until the mission ends, by player (e.g., player gives up) or by the system (e.g., time expires). Each mission generally has its own configuration. A mission may be as long and elaborate as the configuration mandates, though cost and player engagement levels may vary in response.

### Step 9) Reconfiguring of Space

In a typical implementation, the system is operable such that it can reconfigure a physical space (e.g., one or more rooms in a zone) during a mission.

Some advantages associated with having the system being able to control a physical space, are scalability and maximized usage of the physical space. For example, a particular physical space may be carved into multiple smaller spaces. This document uses the terms zone and room, to describe that dynamic. Based on a desired configuration, the system may redefine the usage of the zone to manipulate rooms in the zone so that they support the intent of the mission. Once a room is no longer being used by a particular player undertaking a particular mission, the room is free to be used by another player potentially undertaking another different mission. The system, in a typical implementation, is adapted to accommodate multiple different missions happening in different rooms of the same zone, with one or more of the rooms being used (at different times) by one group of players undertaking one of the missions and then, shortly thereafter, by a second group of players undertaking a second one of the missions.

In this regard, as one player exits a particular room (and enters the next), the system may determine (e.g., based on one or more signals from motion detector component(s)) that the player has moved from one room to the next, and the door, through which the players passed will be closed and locked, thus making the exited room inaccessible by the players who passed to the second room. This also makes the first room available to the system for use in another mission, or for doubling back, if the running Mission so indicates. In a typical implementation, the system will understand the events (e.g., multiple missions) happening in a particular zone and can create an optimized utilization plan for the zone based, for example, on priority, mission status, missions in the queue, and/or the upcoming objectives of each Mission.

In some implementations, after a particular room has been freed, the system may determine the next prioritized use of that room. The system then researches the required configuration for that room based on the mission configuration requirements for utilizing that space. The configuration begins as noted in Step 8 above and the player enters the room. Note that as the Player in the example above exited the first room after submitting a correct challenge response, the system would have configured the player's next room based on the configuration parameters of the player's running mission. Depending on setup time, for example, the system might actually ‘lock’ a space from use and start room manipulation based on what it knows needs to happen next in that mission.

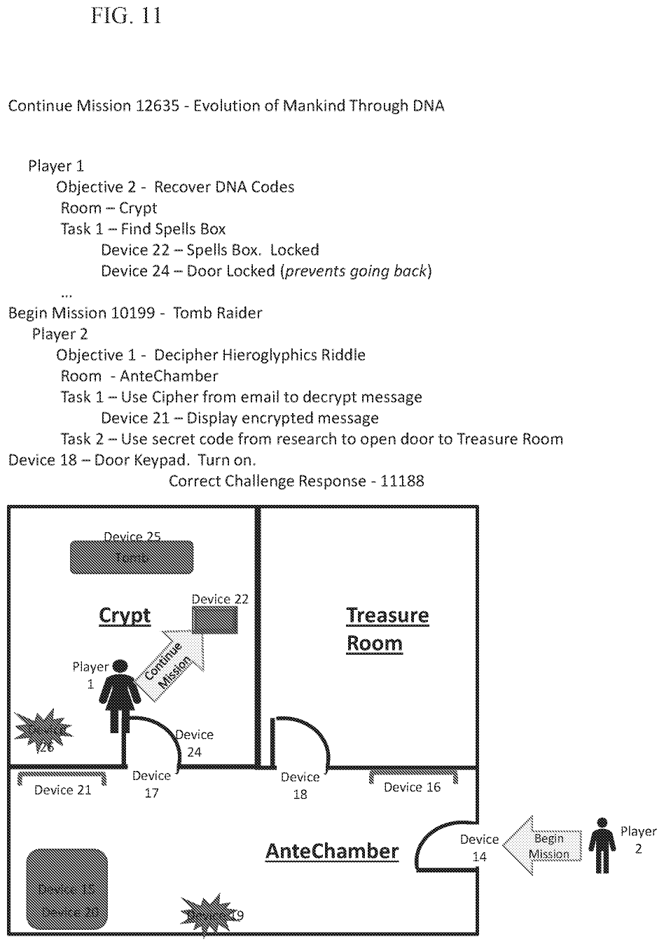

FIG. 11 is a schematic representation showing an exemplary system controlling multiple missions and players at the same zone in multiple rooms.

According to the illustrated representation, player 1 is undertaking one mission (12635, evolution of mankind through DNA), whereas player 2 is undertaking another mission (10199, tomb raider). At the point in time indicated by the schematic representation, player 1 is pursuing objective 2 of his or her mission (remove DNA codes) in the crypt, whereas player 2 is just beginning his or her mission by entering the AnteChamber to pursue objective 1 of his or her mission (decipher hieroglyphics riddle). At this point in time, the door between the AnteChamber (where player 2 will be pursuing one objective) and the Crypt (where player 1 is pursuing another objective) is closed and locked.

Under objective 2 (recover DNA codes), player 1 is trying to accomplish task 1 (find the spells box). This involves two devices: a spells box, which is locked, and the door (device 24), which, again, is locked.

Under objective 1 (decipher hieroglyphics riddle), player 2 will try to accomplish two tasks: task 1 (use cipher from email to decrypt a message), and task 2 (use secret code from research to open door to the treasure room). Task 1 of objective 1, in the illustrated example, involves device 21 (a display for the encrypted message). Task 2 of objective 1, in the illustrated example, involves device 18 (a door keypad), which has a correct challenge response (that will open the door to the treasure room) of 11188.

The information represented in the schematic representation of FIG. 11 will have been entered into the system by the creators of mission 12635 and mission 10199, respectively. The system, however, will determine how to coordinate making both missions occur simultaneously in different parts of the available space.

In a typical implementation, the steps above are components of a single exemplary system that uses thematic instructions from a creator to change the behavior of a physical space. The system controls that space by enabling infinite combinations of instructions. Each grouping of instructions is stored as a mission. When the mission is executed, the system processes each of those instructions on a physical space and solicits inputs from a player working through that mission in that space (zone). The scalability of the system arises from the fact that a mission can be broken down to its base elements and codified with attributes in such a way that the mission can be executed at any zone with space characteristics that match those mission attributes. Nearly infinite distinct zones can also be configured to allow the execution of a single mission at any of those physical places, as long as the place is configured as a zone that has the appropriate rooms and devices.

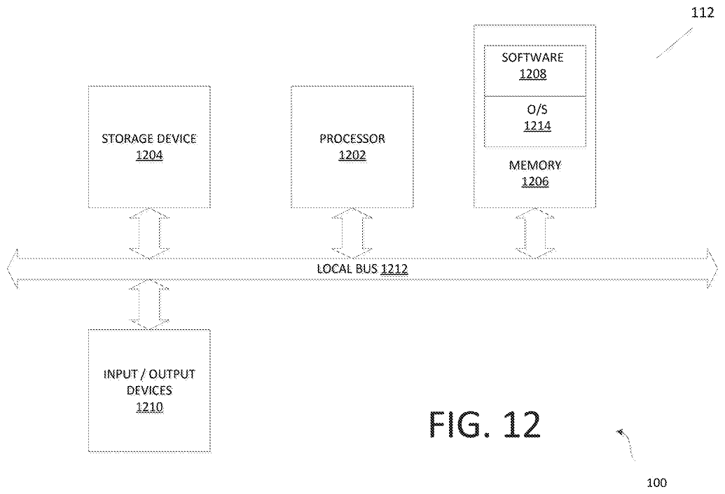

FIG. 12 is a schematic representation of an exemplary computer-based memory and processing system 112.

The illustrated computer-based memory and processing device 112 has a computer-based processor 1202, a computer-based storage device 1204, a computer-based memory 1206 with software 1208 stored therein that, when executed by the processor 1202, causes the processor to provide functionality to support system 100 operations as described herein, input and output (I/O) devices 1210 (or peripherals), and a local bus, or local interface 1212 that allows for internal communication within the computer-based memory and processing device 112. The local interface 1212 can be, for example, one or more buses or other wired or wireless connections. In various implementations, the computer-based memory and processing device 112 may have additional elements, such as controllers, buffers (caches), drivers, repeaters, and receivers, to facilitate communications and other functionalities. Further, the local interface 1212 may include address, control, and/or data connections to enable appropriate communications among the illustrated components.

The processor 1202, in the illustrated example, is a hardware device for executing software, particularly that stored in the special software in memory 1206. The processor 1202 may be custom made and may be a single core or multi-core processor, a central processing unit (CPU), an auxiliary processor among several processors associated with the present server 102, a semiconductor based microprocessor (in the form of a microchip or chip set), a macroprocessor, or generally any device for executing software instructions. In addition, the processing function can reside in a cloud-based service accessed over the internet. The processor can include one or more processing devices and may be geographically distributed.

The memory 1206 can include one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 1206 may incorporate electronic, magnetic, optical, and/or other types of storage media. The memory 1206 can have a distributed architecture, with various memory components being situated remotely from one another, but accessible by the processor 1202.

The software 1208 includes one or more computer programs, each of which contains an ordered listing of executable instructions for implementing logical functions associated with the computer-based memory and processing system 112 (or computer system), as described herein. The memory 1206 may contain an operating system (O/S) 1240 that controls the execution of one or more programs within the computer-based memory and processing system 112, including scheduling, input-output control, file and data management, memory management, communication control and related services and functionality.

The I/O devices 1210 may include one or more of different types of input or output device. Examples include a keyboard, mouse, scanner, microphone, printer, display, etc. In some implementations, a person having administrative privileges, for example, may access the computer-based processing device to perform administrative functions through one or more of the I/O devices 1210.

In a typical implementation, the computer-based processing device 1206 also includes a network interface (not shown in FIG. 12) that facilitates communication with one or more external components via the communications network 114. The network interface can be a physical computer-based interface device. In some instances, for example, the network interface may include one or more modulator/demodulators (i.e., modems); for accessing another device, system, or network), a radio frequency (RF) or other transceiver, a telephonic interface, a bridge, a router, or other device. During system operation, the computer-based memory and processing device 112 receives data and sends notifications and other data via the network interface.

### EXAMPLE

As part of the system's content, a creator might devise the following and configured it into the system with the purpose of teaching the mathematical concepts of Pythagorean Theorem, and multi-variable algebraic equations.

Plot—Mankind is searching to evolve. The secrets to our further evolution were scattered throughout the solar system by an alien life form. On 4 planets there are 4 keys to enhancing our DNA that would let us evolve to a higher state of cognitive thought. The first person to gather these 4 keys and inject them into their DNA will instantly evolve to that higher state. You have been chosen to embark on a Quest to gather these 4 keys.

The first key is on Earth in an Egyptian Pyramid (a zone). The first mission is to move through 2 rooms of an ancient pyramid to recover the key which is in a coffin in the second room.

The objective of the first room is to solve a math problem the components of which are gathered from within the room. Finding each value (task) enables the solving of the math problem. The solution is needed to open the door to the next room. The objective of the second room is to open the coffin and recover the key. Upon solving the math problems, the player submits a challenge response to the system which evaluates for correctness. Players prepare for the Mission, by reviewing training materials (instructional web sites, texts and documents) before beginning the Mission.

A number of embodiments of the invention have been described. Nevertheless, it will be understood that various modifications may be made without departing from the spirit and scope of the invention.

For example, missions have been described herein as being associated with training materials, with the aim that the participants in a mission will need to illustrate an understanding of the training materials in order to advance through certain parts of or complete the mission. However, missions are not necessarily associated with training materials. In some implementations, a mission might simply represent a game that does not include any training materials and/or might be solely for entertainment purposes. In those instances, knowing something about how to solve a challenge may be critical, but if the player already knows that information (e.g., without having consulted specific training materials for the mission), then the enjoyment factor of completing the mission may become more focused on the physical aspects of completing the challenge.

Additionally, the computer system associated with a specific physical zone can have any one of a variety of specific configurations. For example, a given system might have any number of creator terminals, any number of player terminals, any number of zone manager terminals, and other terminals or components. The computer-based memory and processing system can have any number of computer-based memory devices and any number of computer-based processors. These can be housed in a single housing and/or at a single location, or can be physically distributed.

The information to specify a mission or a zone can vary significantly—being far more detailed than disclosed herein or far more general.

In various implementations, one or more of the devices disclosed herein may be configured to communicate wirelessly over a wireless communication network via one or more wireless communication protocols including, but not limited to, cellular communication, ZigBee, REDLINK™, Z-Wave, Bluetooth, WiFi, IrDA, dedicated short range communication (DSRC), EnOcean, and/or any other suitable common or proprietary wireless protocol.

In some implementations, certain functionalities described herein may be provided by a downloadable software application (i.e., an app), or be accessed on a website.

In various embodiments, some of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to include a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Some of the operations described in this specification can be implemented as operations performed by a specially-programmed data processing apparatus (e.g., a processor) on data stored on one or more computer-readable storage devices or received from other sources. The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein as occurring in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Some of the computer-based user-accessible functionalities associated with the system disclosed herein can be accessed from different kinds of electronic computer device, including, for example, cell phones and tablet.

The disclosure herein refers to players and participants. It should be understood that, whether these terms are used in the singular form or plural form, the meaning should be construed broadly to include both or either.

Other implementations are within the scope of the claims.

What is claimed is:

1. A method comprising:
receiving content at a computer system, wherein the content describes a mission for participants that involves the participants attempting to complete one or more tasks in a physical zone, wherein completing at least some of the tasks requires an understanding by the participants of training materials;
providing or constructing the physical zone where one or more missions can take place, and providing one or more physical components that the participants can interact with when undertaking the mission in the physical zone;
receiving parameters at the computer system, wherein the parameters describe the physical zone and the one or more physical components in the physical zone;
comparing the content of the mission to the parameters that describe the physical zone to determine, with the computer system, whether the mission can be undertaken in the physical zone;
if the computer system determines that the mission can be undertaken in the physical zone, presenting the mission and physical zone as an option for the participants; and
controlling the one or more physical components in the physical zone with the computer while the participants are undertaking the mission in the physical zone.

2. The method of claim 1, further comprising:
providing the training materials from the computer system to the participants to review before and/or during the mission.

3. The method of claim 2, wherein the computer system provides the training parameters according to a scheduling parameter provided by a creator of the associated mission.

4. The method of claim 1, further comprising receiving at the computer system signals from the one or more physical components in the physical zone as the participants interact with the one or more physical components during the mission being undertaken.

5. The method of claim 4, wherein the computer system is configured to cause one or more of the physical components in the physical space to change state in response to one or more of the received signals.

6. The method of claim 1, further comprising:
enabling a plurality of users to enter content about different missions into the computer system,
wherein the content entered by each respective user describes and is associated with a different mission,
wherein each different mission involves the participants attempting to complete one or more mission-specific tasks in a mission-specific physical zone, and
wherein, for each different mission, completing at least some of the mission-specific tasks requires an understanding by the participants of mission-specific or generic training materials.

7. The method of claim 6, further comprising enabling users to enter parameters at the computer system that describe different physical zones and one or more physical components in each respective one of the different physical zones.

8. The method of claim 7, wherein the computer system is configured to determine which of the different missions can be undertaken in which of the different physical zones by comparing the content about the different missions with the parameters that describe the different physical zones and the physical components in the different physical zones.

9. The method of claim 8, wherein the computer system is configured to identify to a mission participant, at a computer-based user access terminal:
one or more of the different missions that can be undertaken at a selected one of the different physical zones; and/or
one or more of the different physical zones where a selected one of the different missions can be undertaken.

10. The method of claim 9, wherein a particular one of the different missions is able to be undertaken a particular one of the different physical zones, if requirements of that particular mission set by the content entered for that particular mission, can be satisfied by characteristics of that particular physical zone based on the entered parameters for that particular physical zone.

11. The method of claim 1, wherein multiple groups of participants can undertake different missions at the same time in the physical zone.

12. The method of claim 1, further comprising:
enabling content creators to leverage content created by others, or by themselves for other missions.

13. The method of claim 1, wherein the training materials relate to some real-world training goal that is not related to the mission.

14. The method of claim 1, wherein the computer system is configured to set up the one or more physical components in the physical zone prior to the mission taking place in accordance with the content received at the computer system that describes the mission.

15. The method of claim 1, wherein the content that describes the mission is organized and saved into computer-based memory as mission information, objective information, and task information.

16. The method of claim 15, wherein each mission comprises one or more objectives, and wherein each objective comprises one or more tasks.

17. The method of claim 16, wherein each of the tasks is logically associated in the computer-based memory with one or more physical devices that must be present as a component in a room of the physical zone in order for the physical zone to be able to support a corresponding mission.

18. The method of claim 16, wherein each objective is logically associated in the computer-based memory with a corresponding room in the physical zone that has every device that is required to support the tasks associated with the objectives.

19. The method of claim 15, wherein the objective information, and the task information is stored such that each objective can be readily associated with a corresponding new mission, and such that each task can be readily associated with a corresponding new objective or mission.

20. The method of claim 1, wherein comparing the content of the mission to the physical zone parameters comprises:
determining whether a room type associated with the mission content is represented in the physical zone parameters; and
determining if a device associated with a task to be performed in the room type as represented in the mission content is represented in the physical zone parameters.

21. The method of claim 1, wherein the system is configured to coordinate two or more missions being undertaken utilizing different rooms in the same physical zone to accommodate different objectives in the different rooms for the different missions.

22. A system comprising:
a physical zone where one or more missions can be undertaken, wherein each physical zone is defined at least in part, by a plurality of walls;
one or more physical components in the physical zone that the participants can interact with when undertaking one of the missions in the physical zone;
a computer system configured to receive signals from the one or more physical components as the participants interact with the one or more physical components during the mission being undertaken, and to control the one or more physical components in response to the signals received,
wherein the computer system is further configured to:
receive content that describes a mission for participants that involves the participants attempting to complete one or more tasks in the physical zone, wherein completing at least some of the tasks requires an understanding by the participants of training materials;
receive parameters that describe the physical zone and the one or more physical components in the physical zone;
compare the content of the mission to the parameters that describe the physical zone to determine whether the mission can be undertaken in the physical zone, and, if the computer system determines that the mission can be undertaken in the physical zone, present the mission and physical zone as an option for the participants at a user access terminal.
